(19) United States
(12) Patent Application Publication
(10) Pub. No.: US 2010/0165970 A1
(43) Pub. Date: Jul. 1, 2010

(54) APPARATUS AND METHOD FOR FAST SYNCHRONIZATION IN A DUAL MODE SYSTEM

(75) Inventor: Anthony S. Lee, San Diego, CA (US)

Correspondence Address: HUFFMAN LAW GROUP, P.C., 1900 MESA AVE., COLORADO SPRINGS, CO, 80906, US

(73) Assignee: VIA TELECOM, INC., San Diego, CA (US)

(21) Appl. No.: 12/420,695

(22) Filed: Apr. 8, 2009

Related U.S. Application Data
(60) Provisional application No. 61/140,885, filed on Dec. 25, 2008.

(51) Int. Cl. H04J 3/06; H04B 7/216

(52) U.S. Cl. 370/342; 370/350

(57) ABSTRACT

A method and apparatus is provided for reducing network synchronization time in a dual-mode access terminal. The dual-mode access terminal supports a first and a second network. The method includes determining if CDMA system time is available within the dual-mode access terminal. In response to determining that CDMA system time is available, the method includes forgoing acquiring the CDMA system time through a pilot acquisition procedure, reading the CDMA system time from a memory, and programming the CDMA system time into a system time unit. In response to determining that CDMA system time is not available, the method includes acquiring the CDMA system time through the pilot acquisition procedure and programming the CDMA system time into the system time unit.

### CROSS REFERENCE TO RELATED APPLICATIONS

This application claims benefit of priority of U.S. provisional application Ser. No. 61,140,885 filed Dec. 25, 2008, whose inventor is Anthony Lee, which is hereby incorporated by reference in its entirety as though fully and completely set forth herein.

### FIELD OF THE INVENTION

The present invention relates in general to wireless communication, and more particularly to an apparatus and method to improve synchronization timing in a dual-mode mobile unit.

### BACKGROUND OF THE INVENTION

CDMA2000 is a third-generation (3G) wideband; spread spectrum radio interface system that uses the enhanced service of Code Division Multiple Access (CDMA) technology to facilitate data capabilities, such as internet and intranet access, multimedia applications, high-speed business transactions, and telemetry. The focus of CDMA2000, as is that of other third-generation systems, is on network economy and radio transmission design to overcome the limitations of finite radio spectrum availability. Several improvements have been added under the CDMA200 framework, and are continuing to be added. The CDMA2000 High Rate Packet Data Air Interface Specification, 3GPP2 C.S0024-A Version 2.0, maintained by the 3^{rd} Generation Partnership Project (3GPP2) contains many of the CDMA specifications, and is herein incorporated by reference for all intents and purposes. CDMA access terminals obtain synchronization with access networks by performing the steps illustrated in FIGS. 1 and 2.

Referring now to FIG. 1, a state diagram illustrating the initialization sequence for a related art CDMA access terminal is shown. At an initial state 104, such as power-on, the access terminal enters an inactive state 106. In the inactive state 106, the access terminal waits for the protocol to receive an activate 108 command. If the protocol receives an activate 108 command in the inactive state 106, the access terminal transitions from the inactive state 106 to a network determination state 112. If the protocol receives the activate 108 command in any other state, the access terminal ignores the activate 108 command.

In the network determination state 112, the access terminal selects a CDMA channel. The access terminal selects a channel from a list of preferred networks and once the access terminal selects a network 114, the network determination state 112 transitions to a pilot acquisition state 116.

In the pilot acquisition state 116, the access terminal acquires the forward pilot channel of the selected CDMA channel and acquires CDMA system time information using a CDMA system time parameter the CDMA access network transmits to the access terminal Upon entering the pilot acquisition state 116, the access terminal tunes to the selected CDMA channel and searches for the pilot. If a pilot timer expires 118, the pilot acquisition state 116 transitions back to the network determination state 112. If the access terminal acquires the pilot 122, the access terminal transitions to a synchronization state 126.

In the synchronization state 126, the access terminal completes timing synchronization. If a synchronization message is OK 132, the synchronization state 126 transitions back to the inactive state 106. Once back in the inactive state 106, the air link management protocol can continue to monitor the control channel. If instead the access terminal does not receive a synchronization message, or if the access terminal's revision number is not within the range the synchronization message defines, the access terminal transitions 128 back to the network determination state 112.

FIG. 1 notes that deactivate triggered transitions are not shown. The access network may transmit a deactivate command to the access terminal. If the protocol receives a deactivate command in the inactive state 106, the access terminal ignores the deactivate command. If the protocol receives a deactivate command in any other state 112/116/126, the access terminal transitions to the inactive state 106.

Referring now to FIG. 2, a flowchart illustrating a pilot acquisition procedure within the pilot acquisition state 116 of FIG. 1 is shown. Flow begins at block 204.

At block 204, the access terminal enters the pilot acquisition state 116 from the network determination state 112, and begins a pilot timer. The access terminal enters the pilot acquisition state 116 in response to the access terminal selecting a network 114. The access terminal uses the pilot timer to exit the pilot acquisition state 116 and transition back to the network determination state 112 if the access terminal cannot acquire the pilot within a specified time period. Flow proceeds to block 206.

At block 206, the access terminal acquires the forward pilot channel of the selected CDMA channel. The forward pilot channel is the portion of the forward channel that carries the pilot. The pilot is required in order to synchronize the access terminal with a CDMA access network. Flow proceeds to block 208.

At block 208, the access terminal selects a CDMA channel to search. Flow proceeds to block 212.

At block 212, the access terminal searches the frequencies within the selected channel from blocks 208 or 218 in order to find the pilot. Flow proceeds to decision block 214.

At decision block 214, the access terminal determines if a pilot is found at the frequencies searched in block 212 at the CDMA channel selected in blocks 208 or 218. If the pilot is found, then flow proceeds to block 224. If the pilot is not found, then flow proceeds to decision block 216.

At decision block 216, the pilot has not been found and the access terminal checks if the pilot timer has expired 118. If the pilot timer has not expired, then flow proceeds to block 218. If the pilot timer has expired 118, then flow proceeds to block 222.

At block 218, the access terminal selects a new CDMA channel to search. Flow proceeds to block 212.

At block 222, the pilot timer has expired 118, and the pilot acquisition state 116 transitions back to the network determination state 112. Flow ends at block 222.

At block 224, the access terminal acquires CDMA system time from the CDMA access network. The access terminal must acquire CDMA system time before it can transfer packet data with the CDMA access network. Flow proceeds to block 226.

At block 226, the access terminal acquires a pilot 122, and the access terminal enters the synchronization state 126. Flow ends at block 226.

As can be seen in the steps of FIG. 2, the scanning process to acquire CDMA system time can require a significant number of frequency and channel iterations to find a pilot. If acquiring CDMA system time requires a large number of iterations, the time after initialization before the access terminal can transmit packet data with the CDMA access network can be long. Each iteration to find a pilot additionally requires powering the RF section of the access terminal, which consumes access terminal power. Therefore, what is needed is a means for access terminals to reduce access terminal power and synchronization time with CDMA access networks.

### BRIEF SUMMARY OF INVENTION

The present invention provides a method for reducing network synchronization time in a dual mode access terminal. The dual-mode access terminal supports a first and a second network. The method includes determining if CDMA system time is available within the dual-mode access terminal. In response to determining that CDMA system time is available, the method includes forgoing acquiring the CDMA system time through a pilot acquisition procedure, reading the CDMA system time from a memory, and programming the CDMA system time into a system time unit. In response to determining that CDMA system time is not available, the method includes acquiring the CDMA system time through the pilot acquisition procedure and programming the CDMA system time into the system time unit.

In one aspect, the present invention provides a dual-mode access terminal with reduced network synchronization time. The dual-mode access terminal supports a first and a second network. The dual-mode access terminal includes a memory and a system time unit, coupled to the memory. The dual-mode access terminal determines if CDMA system time is available within the dual-mode access terminal. If CDMA system time is available within the dual-mode access terminal, the dual-mode access terminal forgoes acquiring the CDMA system time through the pilot acquisition procedure, reads the CDMA system time from the memory, and programs the CDMA system time into the system time unit. If CDMA system time is not available within the dual-mode access terminal, the dual-mode access terminal acquires the CDMA system time through the pilot acquisition procedure and programs the CDMA system time into the system time unit.

An advantage of the present invention is that it provides reduced network synchronization time for CDMA networks in dual-mode access terminals by skipping the CDMA system time acquisition procedure within the pilot acquisition state. Skipping the CDMA system time acquisition procedure allows the dual-mode access terminal data to rapidly receive data following power-up or loss of access to the CDMA network. Conventional access terminals must proceed through the CDMA system time acquisition procedure in the pilot acquisition state, which involves repetitive CDMA channel and frequency searching. The present invention achieves the network synchronization state sooner, and thereby allows data transfer between the dual-mode access terminal and the network with less latency by avoiding the repetitive channel and frequency searching.

Another advantage of the present invention is the dual-mode access terminal consumes less power than conventional access terminals. Conventional access terminals obtain CDMA system time in the pilot acquisition state by repeatedly searching CDMA channels and frequencies. The searching process requires powering the RF transceiver in the access terminal. The RF transceiver consumes a large amount of power compared to other circuitry in the access terminal. The present invention bypasses the searching procedure in the pilot acquisition state, and thereby saves power. Additionally, the present invention enters the synchronization state before conventional access terminals enter the synchronization state since the dual-mode access terminal requires the CDMA system time to enter the synchronization state. Therefore, the dual-mode access terminal of the present invention consumes less power than conventional access terminals while acquiring CDMA system time.

### BRIEF DESCRIPTION OF THE DRAWINGS

FIG. 1 is a state diagram illustrating the initialization sequence for a related art CDMA access terminal.

FIG. 2 is a flowchart illustrating a pilot acquisition procedure within the pilot acquisition state of FIG. 1.

FIG. 3 is a block diagram of a dual-mode access terminal system with CDMA and E-UTRAN networks of the present invention.

FIG. 4 is a block diagram of a dual-mode access terminal of the present invention.

FIG. 5 is a block diagram of a receiver portion of the CDMA baseband modem of the present invention.

FIG. 6 is a state diagram illustrating the initialization sequence for the dual-mode access terminal of the present invention.

FIG. 7 is a flowchart of the CDMA system time acquisition procedure for the dual-mode access terminal of the present invention.

### DETAILED DESCRIPTION OF THE INVENTION

CDMA2000 includes both High Rate Packet Data (HRPD) as well as 1 times radio transmission technology (1xRTT) networks. It should therefore be understood that in the context of the present invention, CDMA refers to both HRPD as well as 1xRTT networks.

In addition to CDMA2000 (hereinafter referred to as CDMA), another wireless system is gaining acceptance. E-UTRAN is a wireless data extension of GSM technology. GSM is the Global System for Mobile communications, the most popular standard for mobile telephony in the world. E-UTRAN network stands for “Evolved Universal Terrestrial Radio Access Network”, and is a work item on the 3GPP (3^{rd} generation partnership program) Long Term Evolution. The Air-Interface Evolution will develop a framework for a high-data-rate, low-latency and packet-optimized radio-access technology. Trials started in 2008, products are expected to be commercially available in 2009 and commercial deployments will begin in 2010. The 3GPP Technical Specification Group Radio Access Network Evolved Universal Terrestrial Radio Access (E-UTRA) Radio Access Control (RRC) Protocol Specification (Release 8), maintained by 3GPP contains many of the E-UTRAN network specifications, which is herein incorporated by reference for all intents and purposes.

With the rapid development and momentum of E-UTRAN network technology, there is a desire to offer E-UTRAN compatibility in mobile devices also containing existing CDMA technology. This would allow mobile users to selectively access both types of wireless networks using the same mobile device. For clarity, mobile devices that can act as CDMA access terminals and as E-UTRAN UE (user equipment) devices are referred to as “dual-mode access terminals” from this point onward. A specification has been developed by the 3^{rd} Generation Partnership Project 2 (3GPP2) to form a compatibility standard for facilitating CDMA2000 High Rate Packet Data (HRPD) interworking with E-UTRAN: E-UTRAN network—cdma2000 Connectivity and Interworking: Air Interface Specification Revision 0 3GPP2 C.P0087-0, Version 0.70, Jan. 29, 2009, which is hereby incorporated by reference for all purposes.

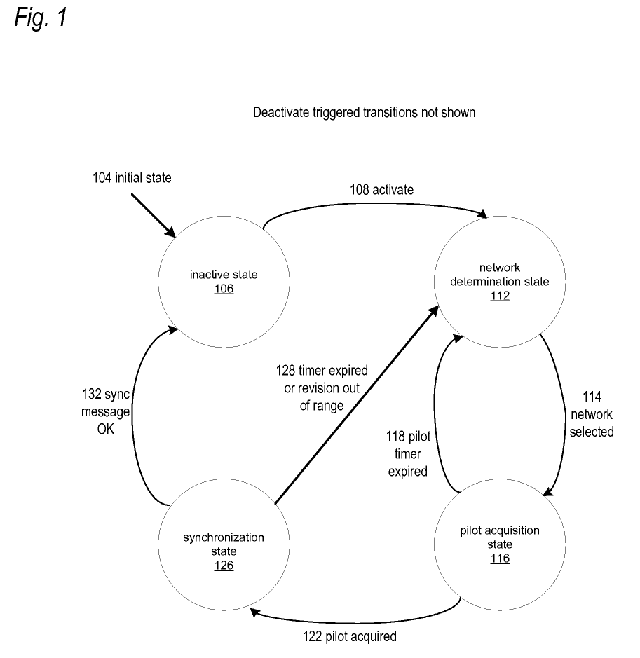

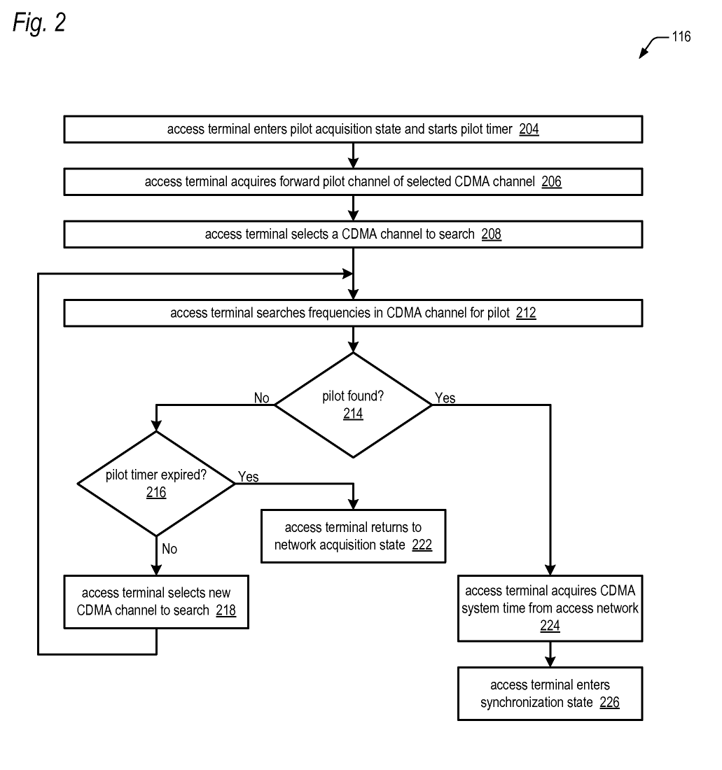

CDMA access terminals acquire system time and enter the synchronization state as previously discussed with respect to FIGS. 1 and 2. Early (pre-production) dual-mode CDMA/E-UTRAN access terminals were dual receiver devices. Dual receiver dual-mode access terminals can simultaneously receive data from both a CDMA and an E-UTRAN network at the same time, but only transmit on either CDMA or E-UTRAN network at any given time. However, dual receiver dual-mode access terminals are expected to be too expensive for mass deployment. Therefore, single receiver dual-mode access terminals will likely be the dominant form of dual-mode access terminals. Single receiver dual-mode access terminals can only transmit and receive data to either a CDMA or an E-UTRAN network, but not both, at the same time. Single and dual receiver dual-mode access terminals must use the method of FIGS. 1 and 2 to synchronize with a network if the only network they can access is a CDMA network.

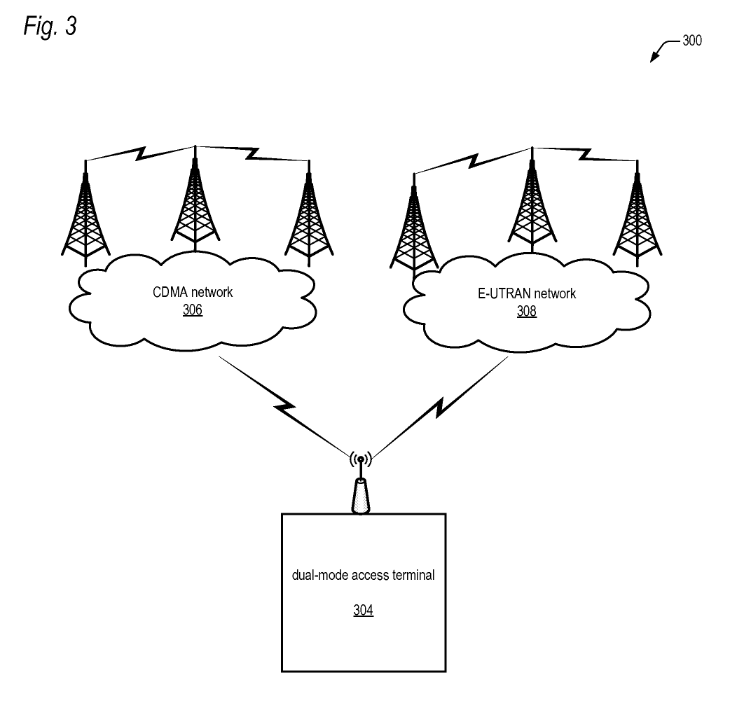

Referring now to FIG. 3, a block diagram of a dual-mode access terminal system 300 with CDMA and E-UTRAN networks of the present invention is shown. The dual-mode access terminal 304 is a mobile device that can communicate with either a CDMA network 306 or a non-CDMA network, as long as the dual-mode access terminal 304 can obtain CDMA system time from the non-CDMA network prior to the pilot acquisition state 116, and thereby avoid acquiring CDMA system time in the pilot acquisition state 116. In a preferred embodiment, the non-CDMA network comprises an E-UTAN network 308. The dual-mode access terminal 304 illustrated in FIG. 3 is a single receiver device, and therefore can only communicate with one of the two networks 306, 308 at the same time.

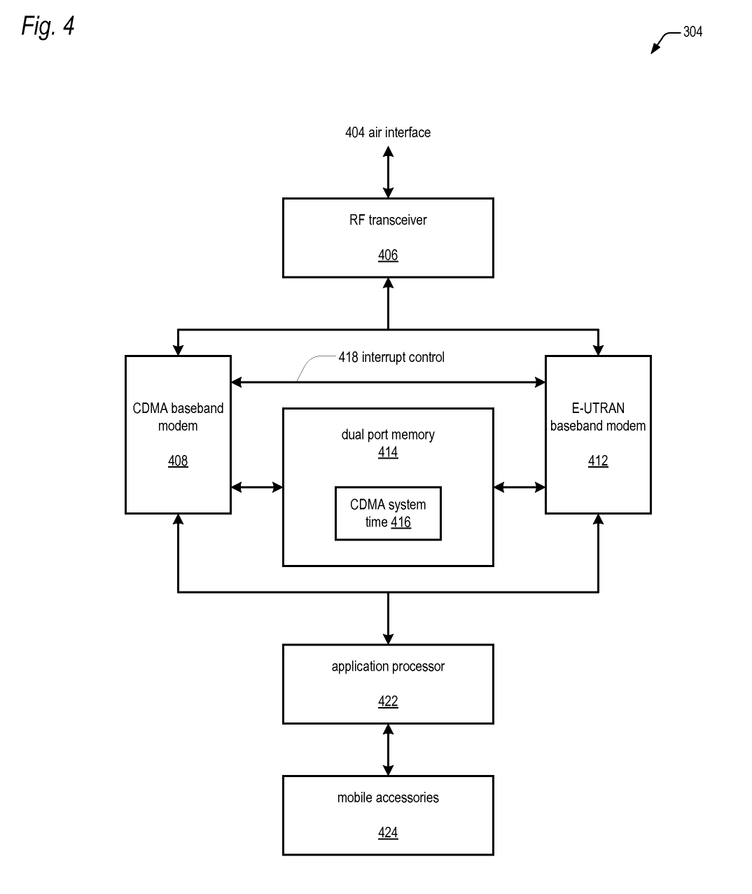

Referring now to FIG. 4, a block diagram of a dual mode access terminal 304 of the present invention is shown. An RF transceiver 406 transmits and receives RF signals over air interface 404 to/from a CDMA access network and/or an E-UTRAN base station. The RF signals contain transmit data, receive data, synchronization data, and many forms of control and status information. The RF transceiver 406 includes analog-to-digital converters, digital-to-analog converters, and various timing circuits to synchronize with the air interface 404.

The RF transceiver 406 is coupled to a modem for each of the radio technologies the dual-mode access terminal 304 supports. In a preferred embodiment, the first radio technology the dual-mode access terminal 304 supports is CDMA. A CDMA baseband modem 408 is a device that modulates an analog carrier signal to encode digital information, and also demodulates such a carrier signal to decode the transmitted information. The CDMA baseband modem 408 produces a signal that the RF transceiver 406 transmits using spread spectrum technology and the CDMA network 306 decodes to reproduce the original digital data.

The second radio technology the dual-mode access terminal 304 supports is a non-CDMA radio technology. In a preferred embodiment, the non-CDMA radio technology is E-UTRAN. An E-UTRAN baseband modem 412 provides similar types of service as the CDMA baseband modem 408. Both the CDMA baseband modem 408 and the E-UTRAN baseband modem 412 provide most of the support for the lower level protocols the CDMA and E-UTRAN radio technologies require. It should be understood that the invention encompasses other non-CDMA radio technologies in addition to E-UTRAN; as long as they can provide a CDMA system time parameter to the dual-mode access terminal 304 faster than a CDMA network 306 can provide the CDMA system time using the pilot acquisition process of FIGS. 1 and 2. Moreover, it should be also understood that the invention encompasses two radio technologies which a first one technology network can provide a CDMA system time parameter faster than a second technology network to the dual-mode access terminal 304. Therefore in a preferred embodiment, the access terminal 304 may comprise two modems corresponding to these first and second network utilizing two different technologies.

The CDMA baseband modem 408 and E-UTRAN baseband modem 412 are coupled to an application processor 422. The application processor 422 executes the upper layer protocols for the CDMA and non-CDMA technologies, and controls the operation of the CDMA baseband modem 408 and the E-UTAN baseband modem 412.

The application processor 422 is coupled to mobile accessories 424. Mobile accessories 424 provide user interface and other functions for the dual-mode access terminal 304. In one embodiment, the mobile accessories include, but are not limited to, a display, a keypad, a USB port, and a Global Positioning System (GPS) unit.

In one embodiment, the dual-mode access terminal 304 stores data used by both the CDMA baseband modem 408 and E-UTRAN baseband modem 412 in a shared memory. In one embodiment, the shared memory is a dual port memory 414. The dual port memory 414 has independent data ports connected to each of the CDMA baseband modem 408 and E-UTRAN baseband modem 412, respectively. In other embodiments, other shared memory arrangements are possible, as long as both modems 408/412 can access the memory.

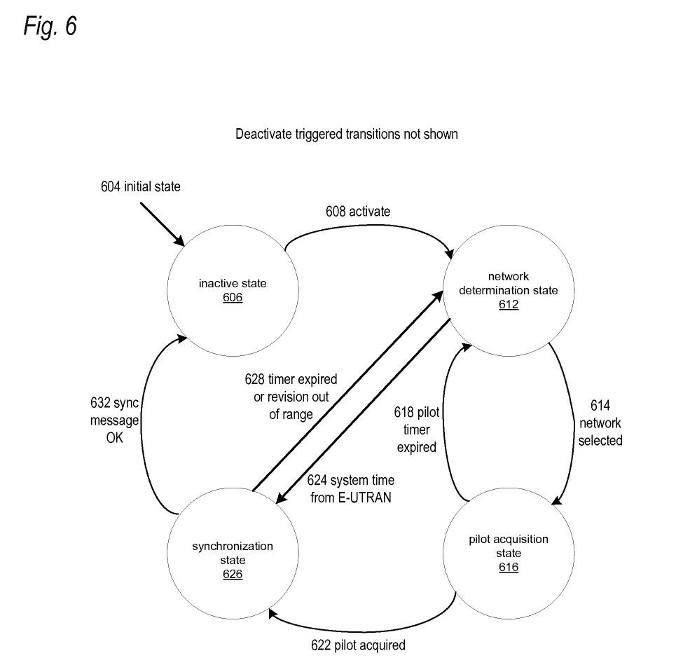

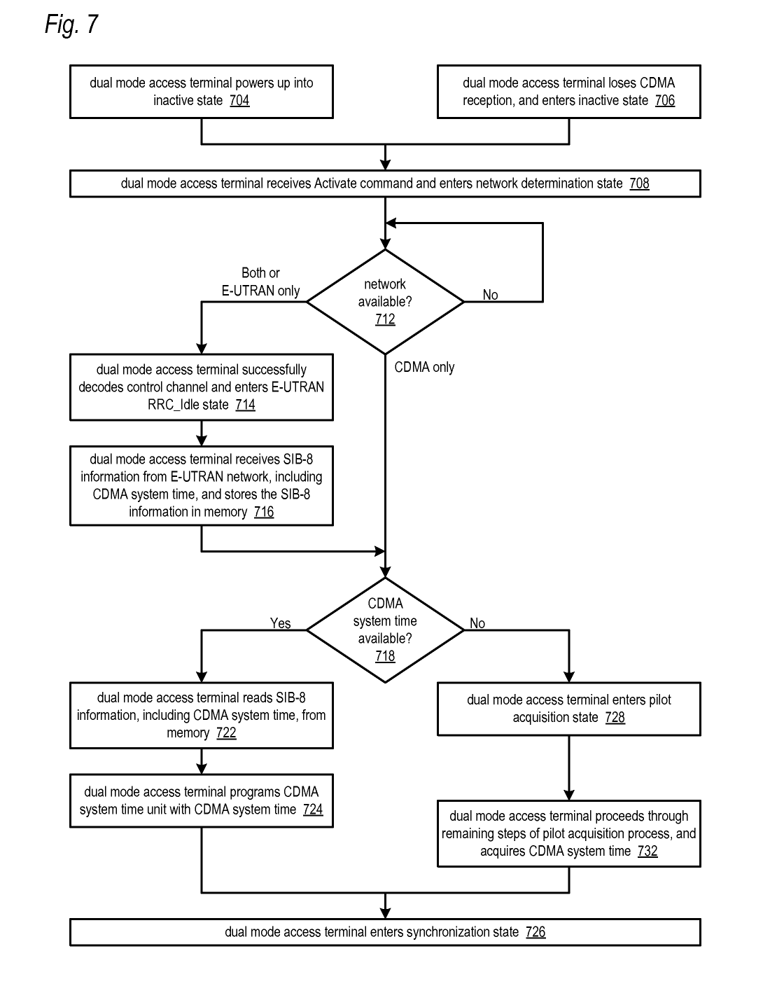

The dual port memory 414 stores the CDMA system time 416. CDMA system time 416 was previously described with reference to FIG. 2, where the CDMA baseband modem 408 acquired the CDMA system time 416 as part of the CDMA pilot acquisition state 116. The E-UTRAN baseband modem 412 also acquires the CDMA system time 416, as described with reference to FIGS. 6 and 7.

The CDMA baseband modem 408 is interconnected to the E-UTRAN baseband modem 412 by interrupt control 418. Interrupt control 418 provides bidirectional interrupts from each modem 408/412 to the other modem 408/412. In one embodiment, the E-UTRAN baseband modem 412 notifies the CDMA baseband modem 408 that the E-UTRAN baseband modem 412 has written the CDMA system time 416 to the dual port memory 414.

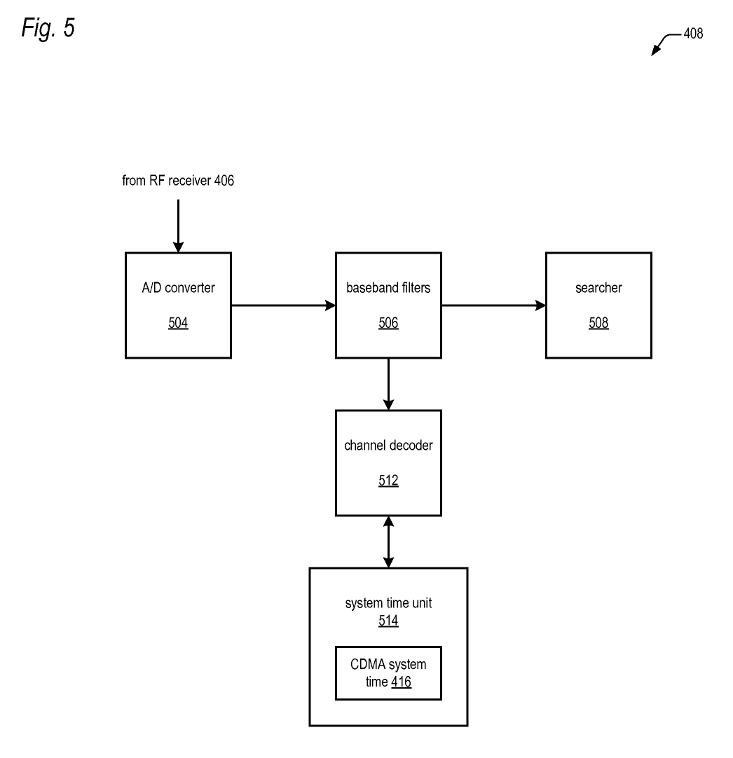

Referring now to FIG. 5, a block diagram of a receiver portion of the CDMA baseband modem 408 of the present invention is shown. The receiver portion of the CDMA baseband modem 408 includes an analog-to-digital (A/D) converter 504, which receives signals from an RF receiver in the RF transceiver 406 for use by baseband filters 506.

Baseband filters 506 eliminate extraneous frequencies and noise in order for the CDMA baseband modem 408 to reliably process received data. The baseband filters 506 transfer filtered receive data to a channel decoder 512. The channel decoder 512 obtains data for the specific channel the CDMA baseband modem 408 is receiving data from, based on the filtered data from the baseband filters 506.

Baseband filters 506 also provide filtered data to a searcher circuit 508. The searcher circuit 508 searches CDMA channels and frequencies in the pilot acquisition state 116 in order to receive the CDMA pilot and acquire CDMA system time 416 from the CDMA network 306, as illustrated in FIGS. 2 and 3. Conventional access terminals do not utilize the present invention, and must obtain the CDMA system time 416 by using the searcher circuit 508. The present invention bypasses the searcher circuit 508 and the pilot acquisition state 116 process to obtain the CDMA system time 416, since the dual-mode access terminal 304 acquires the CDMA system time 416 through the E-UTRAN network 308. This process is described in more detail with respect to FIGS. 6 and 7.

The channel decoder 512 is coupled to a system time unit 514. The CDMA baseband modem 408 programs the system time unit 514 with the CDMA system time 416, in order to enter the synchronization states 126 of FIGS. 1 and 626 of FIG. 6. If the dual-mode access terminal 304 acquires the CDMA system time 416 from the CDMA network 306, the method illustrated in FIGS. 1 and 2 is used to obtain the CDMA system time 416 from the CDMA network 306. If the dual-mode access terminal 304 acquires the CDMA system time 416 from the E-UTRAN network 308, the method illustrated in FIGS. 6 and 7 is used to obtain the CDMA system time 416 from the E-UTRAN network 308.

Referring now to FIG. 6, a state diagram illustrating the initialization sequence for the dual-mode access terminal 304 of the present invention is shown.

At an initial state 604, such as power-on, the dual-mode access terminal 304 enters an inactive state 606. In the inactive state 606, the dual-mode access terminal 304 waits for the protocol to receive an activate command 608. If the protocol receives an activate command 608 in the inactive state 606, the dual-mode access terminal 304 transitions to a network determination state 612. If the protocol receives the activate command 608 in any other state 612/616/626, the dual-mode access terminal 304 ignores the activate command 608.

In the network determination state 612, the dual-mode access terminal 304 selects a CDMA channel from a list of preferred networks. Once the dual-mode access terminal 304 selects a network 614, the network determination state 612 transitions to a pilot acquisition state 616. Additionally, and different from the initialization sequence shown in FIG. 1, the dual-mode access terminal 304 transitions from the pilot acquisition state 616 to a synchronization state 626 if the dual-mode access terminal 304 receives the CDMA system time from the E-UTRAN network 624. The E-UTRAN network 308 provides CDMA system time 416 to the dual-mode access terminal 304 as shown in blocks 714, 716, 722, and 724 of FIG. 7. Because the E-UTRAN network protocol does not require the dual-mode access terminal 304 to search channels and frequencies for the pilot, it is able to provide the CDMA system time 416 to the dual-mode access terminal 304 much faster than a CDMA network 306 can. Therefore, the dual-mode access terminal 304 can transition from the network determination state 612 to the synchronization state 626 much faster and using less power than a conventional access terminal through CDMA network 306.

In the pilot acquisition state 616, the dual-mode access terminal 304 acquires the forward pilot channel of the selected CDMA channel. Upon entering the pilot acquisition state 616, the dual-mode access terminal 304 tunes to the selected CDMA channel and searches for the pilot. If a pilot timer expires 618, the pilot acquisition state 616 transitions back to the network determination state 612. If the dual-mode access terminal 304 acquires the pilot 622, the pilot acquisition state 616 transitions to the synchronization state 626.

In the synchronization state 626, the dual-mode access terminal 304 completes timing synchronization. If a synchronization message is OK 632, the synchronization state 626 transitions back to the inactive state 606. Once back in the inactive state 106, the air link management protocol can continue to monitor the control channel. If instead the dual-mode access terminal 304 does not receive a synchronization message, or if the dual-mode access terminal's 304 revision number is not in the synchronization message range, the dual-mode access terminal 304 transitions 628 back to the network determination state 612.

In an alternate embodiment of FIG. 6, the dual-mode access terminal 304 acquires the CDMA system time 416 in the network determination state 612, as previously stated. However, instead of transitioning directly from the network determination state 612 to the synchronization state 626, the network determination state 612 transitions to the pilot acquisition state 616. Once in the pilot acquisition state 616, the dual-mode access terminal 304 determines if the CDMA system time 416 is already available. If the CDMA system time 416 is already available, then the pilot acquisition state 616 transitions immediately to the synchronization state 626, and skips the search procedure the searcher 508 performs, as described with reference to FIG. 2. If the CDMA system time 416 is not available, then the pilot acquisition state 616 executes the search procedure the searcher 508 performs, as illustrated in FIGS. 1 and 2. Once the searcher 508 acquires the CDMA system time 416, the pilot acquisition state 616 transitions to the synchronization state 626.

FIG. 6 notes that deactivate triggered transitions are not shown. The CDMA network 306 may transmit a deactivate command to the dual-mode access terminal 304. If the protocol receives a deactivate command in the inactive state 606, the dual-mode access terminal 304 ignores the deactivate command. If the protocol receives a deactivate command in any other state, the dual-mode access terminal 304 transitions to the inactive state 606.

Referring now to FIG. 7, a flowchart of the CDMA system time 416 acquisition procedure for the dual-mode access terminal 304 of the present invention is shown. Flow begins at blocks 704 and 706.

At block 704, the dual-mode access terminal 304 powers up into the inactive state 606. Following power-up, the dual-mode access terminal 304 must program the CDMA baseband modem 408 with the CDMA system time 416 before the CDMA portion of the dual-mode access terminal 304 can synchronize with the CDMA network 306. In a preferred embodiment, the dual-mode access terminal 304 powers up with E-UTRAN 308 as the preferred network. Flow proceeds to block 708.

At block 706, the dual-mode access terminal 304 loses reception of the CDMA network 306, and enters the inactive state 606. Following loss of reception to the CDMA network 306, the dual-mode access terminal 304 programs the CDMA baseband modem 408 with the CDMA system time 416 before the CDMA portion of the dual-mode access terminal 304 can synchronize with the CDMA network 306. Flow proceeds to block 708.

At block 708, the dual-mode access terminal 304 receives an activate command 608, and proceeds from the inactive state 606 to the network determination state 612. In the network determination state 612, the dual-mode access terminal 304 begins the process to synchronize, if after power-on, or re-synchronize, if after losing CDMA reception, to the CDMA network 306. Flow proceeds to decision block 712.

At decision block 712, the dual-mode access terminal 304 determines whether the CDMA network 306 or E-UTRAN network 308 is available. If neither network 306, 308 is available, then flow proceeds to block 712 until a network 306, 308 is available. If only the CDMA network 306 is available, then flow proceeds to decision block 718. If both the E-UTRAN network 308 and CDMA network 306 is available, or only the E-UTRAN network 308 is available, then flow proceeds to block 714.

At block 714, the dual-mode access terminal 304 successfully decodes the control channel and enters the E-UTRAN RRC_Idle state. The earlier referenced 3GPP Technical Specification Group Radio Access Network Evolved Universal Terrestrial Radio Access (E-UTRA) Radio Access Control (RRC) Protocol Specification (Release 8), maintained by 3GPP describes the E-UTRAN RRC_Idle state. Flow proceeds to block 716.

At block 716, the dual-mode access terminal 304 receives SystemInformationBlock8 information from the E-UTRAN network 308. The SystemInformationBlock8 contains information about CDMA frequencies and CDMA neighboring cells relevant for cell re-selection. SystemInformationBlock8 includes parameters such as band class, CDMA channel number (frequency), search window size, PN_offset, and the CDMA system time 416. Flow proceeds to decision block 718.

At decision block 718, the dual-mode access terminal 304 determines if the CDMA system time 416 is available in the dual-mode access terminal 304. If the CDMA system time 416 is available in the dual-mode access terminal 304, then flow proceeds to block 722. If the CDMA system time 416 is not available in the dual-mode access terminal 304, then flow proceeds to block 728.

At block 722, the dual-mode access terminal 304 reads SystemInformationBlock8 information, including the CDMA system time 416, from the dual-port memory 414. Flow proceeds to block 724.

At block 724, the dual-mode access terminal 304 programs the CDMA system time unit 514 with the CDMA system time 416 read from the dual-port memory 414 in block 722. At this point, the CDMA system time unit 514 is programmed with the CDMA system time 416 from the E-UTRAN network 308, without requiring the dual-mode access terminal 304 to acquire the CDMA system time 416 using the slower procedure in the pilot acquisition state 116 of FIG. 2 from the CDMA network 306. Flow proceeds to block 726.

At block 728, the dual-mode access terminal 304 enters the pilot acquisition state 616, in preparation for initiating the CDMA system time 416 acquisition process in the pilot acquisition state 616. Flow proceeds to block 732.

At block 732, the dual-mode access terminal 304 proceeds through the remaining steps of the pilot acquisition process, including acquiring the CDMA system time 416. The pilot acquisition procedure for acquiring the CDMA system time 416 is illustrated in FIG. 2. Flow proceeds to block 726.

At block 726, the dual-mode access terminal 304 enters the synchronization state 626. Once in the synchronization state 626, the dual-mode access terminal 304 is ready to communicate with the CDMA network 306. Flow ends at block 726.

Finally, those skilled in the art should appreciate that they can readily use the disclosed conception and specific embodiments as a basis for designing or modifying other structures for carrying out the same purposes of the present invention without departing from the scope of the invention as defined by the appended claims.

We claim:

1. A method for reducing network synchronization time in a dual-mode access terminal, wherein the dual-mode access terminal supports a first and a second network, the method comprising:
determining if CDMA system time is available within the dual-mode access terminal;
in response to determining that CDMA system time is available:
(1) forgoing acquiring the CDMA system time through a pilot acquisition procedure;
(2) reading the CDMA system time from a memory; and
(3) programming the CDMA system time into a system time unit; and
in response to determining that CDMA system time is not available:
(1) acquiring the CDMA system time through the pilot acquisition procedure; and
(2) programming the CDMA system time into the system time unit.

2. The method as recited in claim 1, wherein said determining if CDMA system time is available comprises the dual-mode access terminal determining that the CDMA system time is stored in the memory.

3. The method as recited in claim 1, wherein prior to said determining, the method further comprises:
verifying a connection to the first network;
receiving the CDMA system time from the first network; and
storing the CDMA system time from the first network to the memory.

4. The method as recited in claim 3, wherein said verifying a connection to the first network comprises the dual-mode access terminal decoding a control channel and decoding broadcast information from the first network.

5. The method as recited in claim 3, wherein said receiving the CDMA system time from the first network comprises the dual-mode access terminal receiving system information from the first network to an E-UTRAN baseband modem, wherein the system information comprises the CDMA system time.

6. The method as recited in claim 5, wherein said system information comprises an E-UTRAN SystemInformationBlockType8 information element.

7. The method as recited in claim 3, wherein said storing the CDMA system time from the first network to the memory comprises the E-UTRAN baseband modem writing the CDMA system time to the memory.

8. The method as recited in claim 1, wherein the supported first network comprises an E-UTRAN network and the supported second network comprises a CDMA network.

9. The method as recited in claim 1, wherein the dual-mode access terminal is a single receiver access terminal.

10. The method as recited in claim 1, wherein said reading the CDMA system time from the memory comprises a CDMA baseband modem in the dual-mode access terminal reading the CDMA system time from the memory.

11. The method as recited in claim 1, wherein said programming the CDMA system time into a system time unit comprises a CDMA baseband modem in the dual-mode access terminal writing the CDMA system time to the system time unit.

12. The method as recited in claim 1, wherein the memory is a dual port memory directly coupled to an E-UTRAN baseband modem and a CDMA baseband modem.

13. A dual-mode access terminal with reduced network synchronization time, wherein the dual-mode access terminal supports a first and a second network, comprising:
a memory; and
a system time unit, coupled to the memory;
wherein the dual-mode access terminal is configured to determine if CDMA system time is available within the dual-mode access terminal;
if CDMA system time is available within the dual-mode access terminal, the dual-mode access terminal forgoes acquiring the CDMA system time through a pilot acquisition procedure, reads the CDMA system time from the memory, and programs the CDMA system time into the system time unit; and
if CDMA system time is not available within the dual-mode access terminal, the dual-mode access terminal acquires the CDMA system time through the pilot acquisition procedure and programs the CDMA system time into the system time unit.

14. The dual-mode access terminal as recited in claim 13, wherein the dual-mode access terminal determines if CDMA system time is available within the dual-mode access terminal comprises the dual-mode access terminal determines that the CDMA system time is stored in the memory.

15. The dual-mode access terminal as recited in claim 13, wherein the dual-mode access terminal determines if CDMA system time is available within the dual-mode access terminal after the dual-mode access terminal is further configured to verify a connection to the first network; receive the CDMA system time from the first network, and store the CDMA system time from the first network to the memory.

16. The dual-mode access terminal as recited in claim 15, wherein the dual-mode access terminal verifies a connection to the first network comprises the dual-mode access terminal decodes a control channel and decodes broadcast information from the first network.

17. The dual-mode access terminal as recited in claim 15, wherein the dual-mode access terminal receives the CDMA system time from the first network comprises the dual-mode access terminal receives system information from the first network to an E-UTRAN baseband modem, wherein the system information comprises the CDMA system time.

18. The dual-mode access terminal as recited in claim 17, wherein the system information comprises an E-UTRAN SystemInformationBlockType8 information element.

19. The dual-mode access terminal as recited in claim 15, wherein the dual-mode access terminal stores the CDMA system time from the first network to the memory comprises the E-UTRAN baseband modem writes the CDMA system time to the memory.

20. The dual-mode access terminal as recited in claim 13, wherein the supported first network comprises an E-UTRAN network and the supported second network comprises a CDMA network.

21. The dual-mode access terminal as recited in claim 13, wherein the dual-mode access terminal is a single receiver access terminal.

22. The dual-mode access terminal as recited in claim 13, wherein the dual-mode access terminal reads the CDMA system time from the memory comprises a CDMA baseband modem in the dual-mode access terminal reads the CDMA system time from the memory.

23. The dual-mode access terminal as recited in claim 13, wherein the dual-mode access terminal programs the CDMA system time into the system time unit comprises a CDMA baseband modem in the dual-mode access terminal writes the CDMA system time to the system time unit.

24. The dual-mode access terminal as recited in claim 13, wherein the memory is a dual port memory directly coupled to an E-UTRAN baseband modem and a CDMA baseband modem.
